(19) United States
(12) Patent Application Publication
(10) Pub. No.: US 2025/0131454 A1
(43) Pub. Date: Apr. 24, 2025

(54) SYSTEM AND METHOD FOR SAAS DATA CONTROL PLATFORM

(71) Applicant: ROYAL BANK OF CANADA, Toronto (CA)

(72) Inventors: Salah SHARIEH, Toronto (CA); Fatima Javaid HUSSAIN, Toronto (CA); Evgenii OSTANIN, Toronto (CA); Brett NOYE, Toronto (CA); Paula DUZI, Toronto (CA); Haoyue BAI, Toronto (CA); Nebojsa DJOSIC, Toronto (CA)

(73) Assignee: ROYAL BANK OF CANADA, Toronto (CA)

(21) Appl. No.: 18/920,872

(22) Filed: Oct. 19, 2024

Related U.S. Application Data
(60) Provisional application No. 63/591,549, filed on Oct. 19, 2023.
(60) Provisional application No. 63/591,560, filed on Oct. 19, 2023.
(60) Provisional application No. 63/591,566, filed on Oct. 19, 2023.
(60) Provisional application No. 63/591,646, filed on Oct. 19, 2023.
(60) Provisional application No. 63/591,690, filed on Oct. 19, 2023.
(60) Provisional application No. 63/655,183, filed on Jun. 3, 2024.

(51) Int. Cl. G06Q 30/018; G06N 20/00

(52) U.S. Cl. CPC G06Q 30/018; G06N 20/00

(57) ABSTRACT

There is provided a layered anomaly detection system. The system may perform real-time compliance anomaly detection using a plurality of anomaly-detecting machine learning (ML) models. The system includes a pre-processing subsystem which classifies population sets within a system and defines a plurality of context spaces, clusters objects and labels for each population member. The system trains a plurality of ML anomaly detection models based on received compliance events. The ML anomaly detection models may output an anomaly detection score and a confidence score. One or more ensemble ML models may be used to enhance accuracy.

### CROSS-REFERENCE TO RELATED APPLICATIONS

This claims priority to and the benefit of U.S. Provisional Patent Application No. 63/591,549, filed Oct. 19, 2023, U.S. Provisional Patent Application No. 63/591,560, filed Oct. 19, 2023, U.S. Provisional Patent Application No. 63/591,566, filed Oct. 19, 2023, U.S. Provisional Patent Application No. 63/591,646, filed Oct. 19, 2023, U.S. Provisional Patent Application No. 63/591,690, filed Oct. 19, 2023, and U.S. Provisional Patent Application No. 63/655, 183, filed Jun. 3, 2024, the entire contents of each of the above-identified applications being incorporated herein by reference.

### FIELD

This relates generally to computerized systems for use with Software-as-a-Service applications, and in particular to systems for detecting anomalous behaviour.

### BACKGROUND

The use of computerized systems and software has become ubiquitous throughout organizations. In many organizations, the use of third party Software-as-a-Service (SaaS) applications (i.e. SaaS applications which are created and administered outside of the organizing using the SaaS) is becoming increasingly common, as modern communications systems have overcome bandwidth limitations which might have limited the utility of such SaaS applications in the past. Moreover, an increasing number of vendors have shifted to only offering SaaS distribution models.

However, there are a number of challenges inherent with the use of third party SaaS applications for organizations. For example, an organization may be subject to regulations and/or compliance requirements to which the organization is required to adhere. When computer and/or software systems are developed and implemented within an organization, such systems may be tailored to the specific regulations and/or compliance requirements to which the organization is bound. However, third party SaaS applications may not have been developed with a particular set of regulations or compliance requirements in mind, particularly given that compliance requirements might vary from customer to customer, and as such there might not be a uniform set of standards for to which a particular SaaS application must adhere.

For many organizations, adherence to regulatory and compliance requirements is of paramount importance and ensuring that any proposed new SaaS is compliant with regulations and/or compliance requirements may be a time-consuming and onerous task, which may prevent, impede or retard the adoption of improved technologies and services.

Moreover, ensuring that an existing SaaS application is indeed compliant with regulations and compliance requirements may be an onerous and time-consuming task, and compliance verification may be conducted infrequently as a result. Failure to adequately monitor such operation may introduce threats to an organization, both from the perspective of the risk of non-compliance, and to system security.

In addition, conventional compliance systems may raise many false positive alerts for non-compliance and anomalous behaviours. This may create unreasonable workloads for reviewers, approvers, and technical staff charged with configuring the compliance monitoring system.

Accordingly, there is a need for a computing system which monitors for compliance events and reduces the number of false positive alerts raised.

### SUMMARY

According to an aspect, there is provided a method of detecting anomalous behaviour in a network, the method comprising: in a pre-processing phase, classifying a full population set to discover context-specific classes via a clustering analysis of each sub-population within said full population set and storing said classification in a population data store; training a plurality of machine learning classification engines based on said population data store and on received compliance and audit events for an application; receiving a current event; processing, by said plurality of machine learning classification engines, said current audit event to obtain an anomaly score and a confidence score from each respective classification engine; determine whether said current event is an anomalous event based on said respective anomaly scores and confidence scores.

According to another aspect, there is provided a system for detecting anomalous behaviour in a network, the system comprising: one or more processors; a non-transitory computer-readable storage medium having stored thereon processor-executable instructions that, when executed by said one or more processors, cause the one or more processors to perform a method comprising: in a pre-processing phase, classifying a population set to discover context-specific classes via a clustering analysis of each sub-population within said population set and storing said classification in a population data store; training a plurality of machine learning classification engines based on said population data store and on received compliance and audit events for an application; receiving a current event; processing, by said plurality of machine learning classification engines, said current audit event to obtain an anomaly score and a confidence score from each respective classification engine; determine whether said current event is an anomalous event based on said respective anomaly scores and confidence scores.

According to still another aspect, there is provided a non-transitory computer-readable storage medium having stored thereon processor-executable instructions that, when executed by one or more processors, cause the one or more processors to perform a method comprising: in a pre-processing phase, classifying a population set to discover context-specific classes via a clustering analysis of each sub-population within said population set and storing said classification in a population data store; training a plurality of machine learning classification engines based on said population data store and on received compliance and audit events for an application; receiving a current event; processing, by said plurality of machine learning classification engines, said current audit event to obtain an anomaly score and a confidence score from each respective classification engine; determine whether said current event is an anomalous event based on said respective anomaly scores and confidence scores.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example server, or client computing device;

FIG. 3 depicts a simplified arrangement of software at a server or client computing device;

FIG. 4 is an illustration of an example high-level real-time processing context;

FIG. 5 depicts actors and relationships which explain how and why audit and compliance events resulting from employee actions are received by an organization;

FIG. 6 depicts certain example types of data created during an example pre-processing process;

FIG. 7 depicts an example flow chart for pre-processing population sets in order to discover context-specific classes;

FIG. 8 is a block diagram depicting simplified relationships between pre-

processing, real-time processing, and post-processing sub-systems;

FIG. 9 is a block diagram depicting a process of developing and updating real-time subsystem, in accordance with some embodiments;

FIG. 10 depicts operation of an example real-time processing subsystem; and

FIG. 11 is a block diagram depicting an example anomaly detection process using a plurality of anomaly detection models in an ensemble configuration.

### DETAILED DESCRIPTION

At present a given organization may use dozens or even hundreds of Software-as-a-Service (SaaS) solutions across various lines of business, and which have varying degrees of complexity (e.g. some may use confidential data, others may use sensitive data, still others may use restricted data, and the like). Such SaaS applications may be executing on different cloud platforms, although many SaaS applications may be concentrated within a few large cloud providers (e.g. AWS).

When an organization decides whether to make use of a new SaaS solution, an organization must determine whether the SaaS solution is compliant with regulatory and compliance requirements, and this may be difficult to determine in an expedient manner. There are many different approaches to assessing regulatory compliance and risk (e.g. Supplier Risk Management Assessments (SRMA), Shared SaaS Responsibility Assessments (SSRA), Supplier Controls Assessments (SCA), and the like), many of which are questionnaire-based and require inputs from both users and suppliers to make an assessment. Completion of such assessments can be quite time-consuming, which limits the ability for SaaS solutions to be adopted in a timely manner, and which may pose significant inconvenience internally within an organization.

As described herein, some embodiments may provide data-driven automation for SaaS applications which facilitates processing of compliance evidence and continuous real-time risk assessment. Some embodiments may facilitate automation of onboarding processes for SaaS applications to ensure that a SaaS application is compliant from the beginning, and/or to reduce the amount of time required to certify a SaaS application as compliant. Some embodiments may allow for automation of compliance assessments for SaaS applications which run on computing platforms which are external to an organization's network (e.g. SaaS applications running on public and/or third-party cloud computing platforms, such as Amazon Web Services (AWS)). In some embodiments, systems disclosed herein may facilitate identification of dependences and patterns which exist between a plurality of SaaS applications (e.g. dependencies which may exist between SaaS applications relating to customer relationship management, business process management, human resource management, and the like).

In some embodiments, systems and methods disclosed herein may allow for one or more of: SaaS applications being adopted and onboarded faster than traditional methods, resulting in reduction of the time required to implement a new SaaS application, a reduction in the cost of onboarding an SaaS application, a reduction in the costs associated with regulatory compliance for a given SaaS application, a reduction in the cost of governance and management associated with a given SaaS application, real-time access to risk and compliance data relating to an SaaS, more accurate risk and compliance data, the ability to demonstrate alignment/compliance with regulatory requirements, and/or the ability to more quickly recognize which SaaS applications require further attention and/or scrutiny.

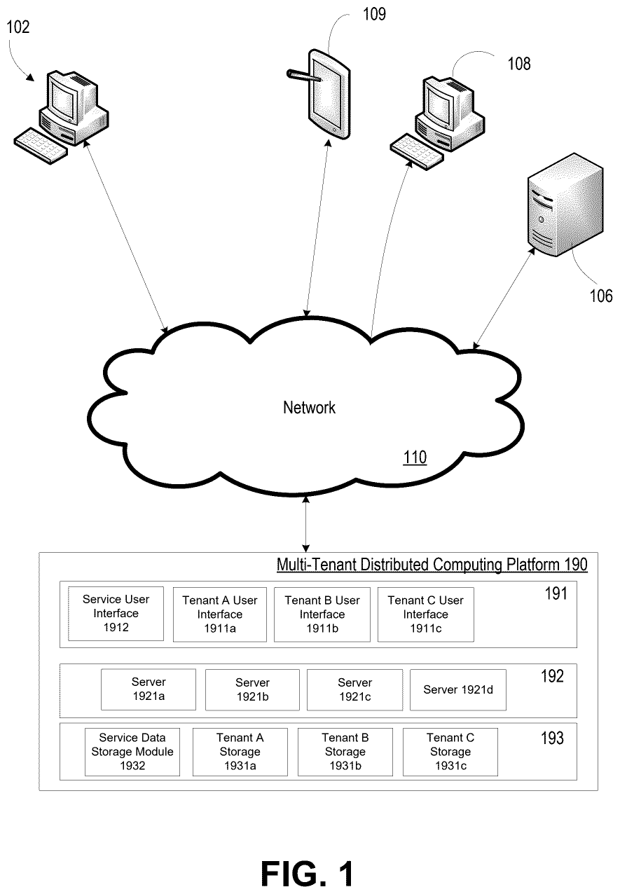

Various embodiments of the present invention may make use of interconnected computer networks and components. FIG. 1 is a block diagram depicting components of an example multi-tenant operating environment. Components of the computing system are interconnected to define a compliance and risk assessment system. As used herein, the term “compliance and risk assessment system” refers to a combination of hardware devices configured under control of software and interconnections between such devices and software. Such systems may be operated by one or more users or operated autonomously or semi-autonomously once initialized.

As depicted, the operating environment includes a variety of clients incorporating and/or incorporated into a variety of computing devices which may communicate with a distributed computing platform 190 via one or more networks 110. For example, a client may incorporate and/or be incorporated into client application implemented at least in part by one or more computing devices. Example computing devices may include, for example, at least one server 102 with a data storage 104 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1.

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the distributed computing platform 190 may provide access to one or more software applications, such as Software-as-a-Service (SaaS) applications to one or more users or “tenants”. As depicted, distributing computing platform 190 may include multiple processing layers, including a user interface layer 191, an application server layer 192, and a data storage layer 193.

In some embodiments, the user interface layer 191 may include a user interface (e.g. service UI 1912) for the platform 190 to provide access to applications and data for a user (or “tenant”) of the service, as well as one or more user interfaces 1911a, 1911b, 1911c, which may be specialized in accordance with specific tenant requirements which may be accessed via one or more Application Programming Interfaces (APIs). It will be appreciated that each processing layer may be implemented using a plurality of computing devices and/or components as described below, and may perform various operations and functions to implement, for example, a SaaS application. In the some embodiments, the data storage layer 193 may include, for example, a data storage module for the service, as well as one or more tenant data storage modules 1931a, 1931b, 1931c which may contain tenant-specific data which is used in providing tenant-specific services or functions.

In some embodiments, platform 190 may be operated by an entity (e.g. Amazon, Microsoft, Google, or the like) in order to provide multiple tenants with applications, data storage, and functionality. A multi-tenant system as depicted in FIG. 1 may include multiple different applications (e.g. multiple different SaaS applications) and data stores, and may be hosted on a distributed computing system which includes multiple servers 1921a, 1921b, 1921c. In some embodiments, the server(s) 1921a, 1921b, 1921c and the services they provide are referred to as the host, and remote computers external to platform 190 and the software applications executing thereon are referred to as clients.

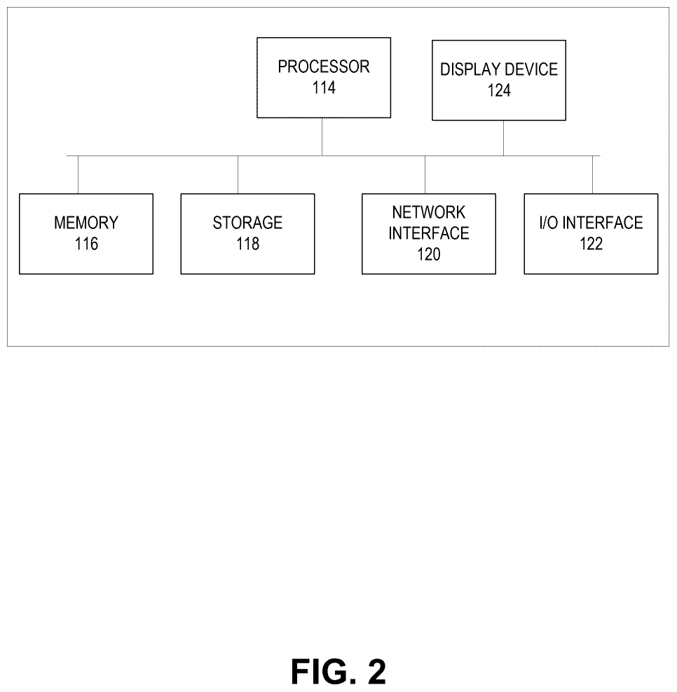

FIG. 2 is a block diagram depicting components of an example computing device, such as a desktop computing device 102, server 1921, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the operation of third party SaaS applications (e.g. SaaS applications hosted by platform 190) to processor 114 and/or to other computing devices. In some embodiments, I/O interface 122 may be compatible with protocols such as WiFi, Bluetooth, and other communication protocols. Software may be loaded onto one or more computing devices. Such software may be executed using processor 114.

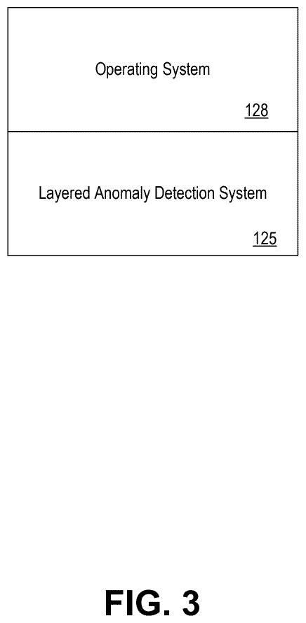

FIG. 3 depicts a simplified arrangement of software at an example computing device. The software may include an operating system 128 and application software, such as layered anomaly detection system 125. It will be appreciated that in distributed computing environments, implementation and administration of an application such as a SaaS application or layered anomaly detection system 125 may be distributed amongst a plurality of separate computing devices, and FIG. 3 is intended to depict a simplified logical separation between an operating system and an application executing thereon on an example computing device.

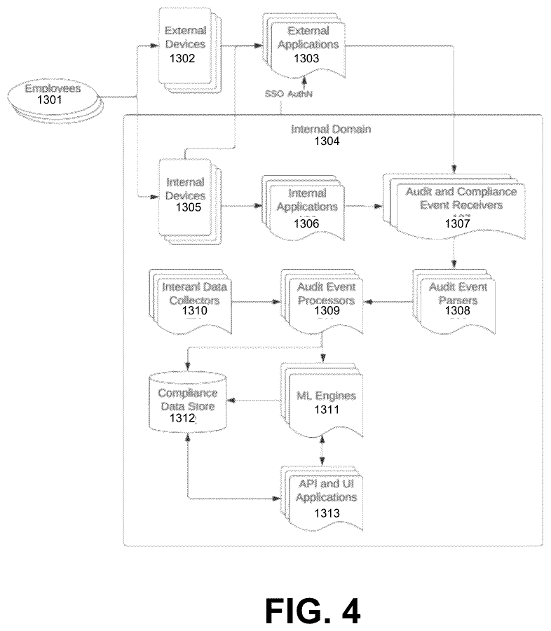

During operation of a SaaS application, compliance controls are used to monitor and collect compliance evidence from applications running in cloud operating environments. For example, specific cloud environment (e.g. AWS, Google Cloud Platform, Microsoft Azure, or the like) compliance controls may be implemented by a SaaS application and the cloud provider (e.g. AWS) and may generate compliance evidence. In some embodiments, compliance evidence may be stored in a data repository, such as compliance data store 1312 depicted in FIG. 4. An example system which monitors and collects compliance evidence is described in U.S. Provisional Patent Application No. 63/591,549, filed Oct. 19, 2023, the entire contents of which are incorporated herein by reference.

As will be appreciated, a related topic to compliance monitoring is monitoring a system for risks. For example, anomalous behaviour within a system or SaaS application may be more harmful to the overall system relative to an application which is potentially non-compliant with a relevant policy. The monitoring and identification of anomalous behaviour is a significant risk which would be beneficial to monitor in a compliance monitoring system.

In some embodiments, there is provided a layered, flexible system configured to perform real-time compliance anomaly detection. In some embodiments, the system may employ multiple anomaly-detecting machine learning (ML) models trained using overlapping, pre-classified data sets. In some embodiments, the datasets may be created using clustering of several populations (such as users and applications), as described below.

In a typical anomaly detection solution, the system is able to detect anomalies “out of the box”, and users are able to receive alerts, review the alerts, and react to the alerts. However, such systems create a substantial amount of manual work for reviewers, approvers, and technical staff, who will then be required to learn and understand how to configure the system to reduce the number of false positives and false negatives generated. This is especially true in the case of large corporations, where distributed offices and a wide variety of employee roles, as well as a wide variety of applications in use, will require a generalized approach to anomaly detection, as false positives and false negatives will be inevitable.

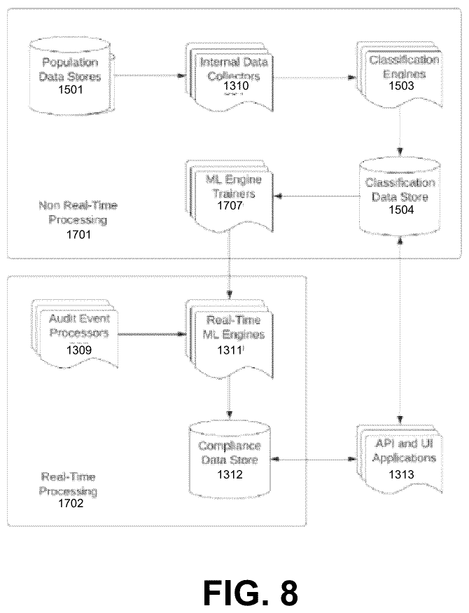

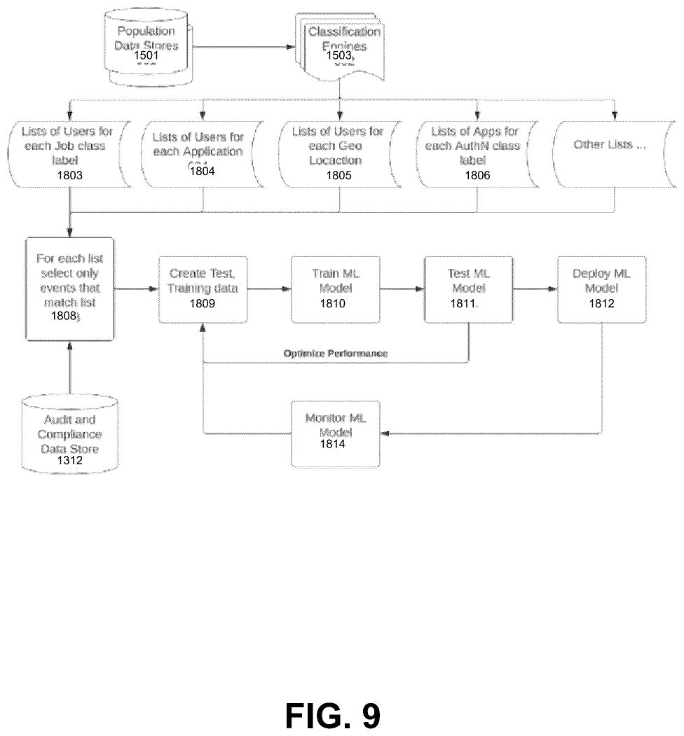

In some embodiments, and as depicted in FIG. 8 and FIG. 9, an example layered anomaly detection system may be subdivided into three subsystems: pre-processing 1701, real-time processing 1702, and post-processing 1814 (e.g. a feedback loop of evaluation and monitoring machine learning models).

As described below, pre-processing 1701 relates to data classification machine learning models. The output of the pre-processing subsystem may be used for development and training of ML models which may be used for anomaly detection. As depicted in FIG. 9, at block 1814, the post-processing subsystem may perform automated, and/or continuous evaluation and monitoring, with a view to refining and optimizing ML models.

FIG. 4 is an illustration of an example high-level real-time processing context. As depicted, employees 1301 may be using external devices 1302 and internal devices 1305. From external devices 1302, employees may access external applications 1303. From external devices 1302, employees might not be able to access internal domain 1304, and therefore might not be able to access internal applications 1306.

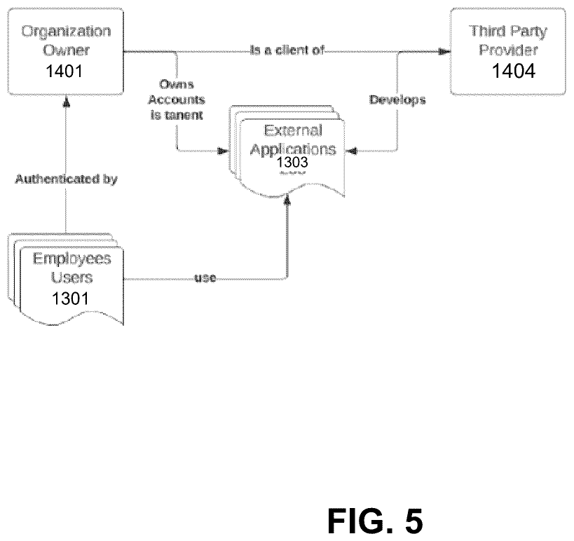

Contrastingly, from internal devices 1305, employees 1301 may be able to access both external applications 1303 and internal applications 1306. As depicted in FIG. 5, when employees 1301 are accessing external applications 1303, employees 1301 may be accessing corporate accounts and may be required to be authenticated.

FIG. 5 depicts actors and relationships which explain how and why audit and compliance events resulting from employee actions are received by the organization 1401 (which employs employees 1301 and is a client of the provider 1404 of third party applications 1303). As depicted, owner 1401 has accounts for using external applications 1303 which are used by employees 1301. Thus, returning to FIG. 4, when an event is received by audit event receiver 1307, the event can be attributed to a specific employee 1301 even if the employee 1301 is using an external device 1302 to access external application 1303.

Since the same employee 1301 may be using internal applications 1306 at the same time as external applications 1303, the audit event processor 1309 may be configured to process both internal and external events, and machine learning engines 1311 may be configured to perform anomaly detection using all available data from both internal applications 1306 and external applications 1303.

Given that events may be received from many different sources and in many different formats, in some embodiments audit event receivers 1307 and audit event parsers 1308 may be used to standardize data to a format which audit event processors 1309 can use.

In some embodiments, audit event processors 1309 collect internal data using collectors 1310 in order to supplement event data with additional attributes coming from internal data stores (e.g. employee attributes and application attributes).

In some embodiments, some of the aforementioned internal data may be created through pre-processing steps, as described below. In some embodiments, the internal data may be used to train ML engines 1311, with the results of real-time processing by ML engines 1311 being stored in compliance data store 1312. In some embodiments, results of real-time processing may be further accessed by an application programming interface (API) and/or applications (depicted as block 1313) and used for other tasks such as data presentation and visualization, operation, administration, and configuration.

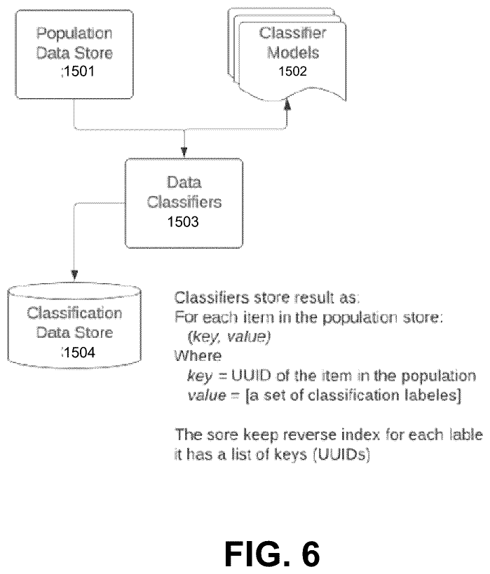

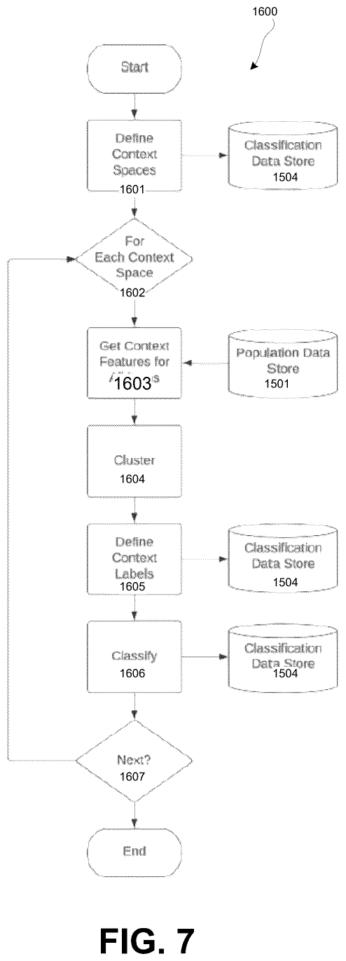

FIGS. 6 and 7 depict example pre-processing steps which may generate internal data which supplements event data. As depicted in FIG. 6, population data store 1501 may be a source of supplemental data population data, which may be used to train classifier models 1502. In some embodiments, data classifiers (also referred to as classification engines herein) 1503 may store results of classification in classification data store 1504. For example, for each item in population store 1501, the output from a classifier 1503 may be in a format having a (key, value) structure, in which a key is a unique universal identifier (UUID) of the item in the population data store, and the value field contains one or more classification labels). In some embodiments, the classification data store 1504 may maintain a reverse index for each label containing a list of keys. In some embodiments, internal data may also be used to train ML engines 1311. The results of real-time processing by ML engines 1311 may be stored to compliance data store 1312, which may then be used to further refine the systems as described herein.

Turning to FIG. 7, an example flow chart for pre-processing population sets in order to discover context-specific classes is described. Process 1600 may perform a clustering analysis of each population as a whole, using different subsets of features in order to prepare multi-label classes (thereby allowing for the training of several multi-class ML classifiers).

In some embodiments, clustering with supervised and semi-supervised learning may be the most suitable approach in order to offer stakeholders an opportunity to define meaningful labels 1605. However, supervised and semi-supervised learning approaches are expensive and time-consuming because they require expert knowledge in both the contextual domain and the machine learning domain. As such, unsupervised learning is significantly easier to implement, deploy and automate than supervised and semi-supervised approaches. However, anomaly detection in dense regions is notoriously difficult without domain expertise. As such, layering is an important aspect of some embodiments, as it allows stakeholders (in some cases, expert users) to express their domain expertise without comprising performance and automation.

In some embodiments, each layer may be independent and may encapsulate specific functionality in a manner which is intuitive to the domain expert, which allows them to interact with the system without the need to comprehend the exact manner in which the system works. Advantageously, integration between layers in the present disclosure allows for domain expertise to flow through from one layer to the next, and to be efficiently used across layers for processes.

In the preprocessing phase, each of user data, application data and other data may be classified. Users may be classified as employees, and Human Resources (HR) records may be used as a population. Users/employees may be classified multiple times, with the resulting set of class labels stored for each in classification data store 1504. For example, each employee may be classified with respect to demographics, qualifications, job, job history, access level (e.g. permissions), and the like.

Similarly, internal and external applications that are available to employees/users may also be classified multiple times with respect to criteria such as access, data, security, budget, integration pattern, and the like. It will be appreciated that the aforementioned criteria are merely examples and many other criteria may be used for classifying users/employees and applications.

Real-time processing subsystem 1702 may be an independent, standalone component. Real-time processing subsystem 1702 may require that ML models are trained using data sets generated using multi-label classifiers. In some embodiments, these classifiers are built during the pre-processing phase.

In some embodiments, in the context of a large organization, the population of human users and/or employees in that organization may be the most important population from a training perspective. The data set associated with the population of human users will have standard types of data such as demographic data, job data, qualification data, performance data, other job-related history data, current assignments and relationships, and other data typically found in a Human Resources data set.

Another significant data set is the population of software applications, devices, assets, and the like which are used by human users. These data sets may include attributes defining, for example, whether software applications and/or devices are internal or external, whether they are restricted to a specific group or groups of human users or open to the whole population, whether they require training, special skills, whether they require higher authorization levels, and so on.

Other data which may be used as an input to training data sets may be, for example, a database of incidents such as outages or users being locked out, a database of exemptions for compliance violations, and the like. In some embodiments, these data sets may have to be pre-processed in order to first define classification levels, and then these labels may be used to classify populations.

These subsets of populations which are classified based on class levels may then be used as a basis for creating data sets for selecting events that are directly related to these subsets, which may then be used for training anomaly detection ML models. In some embodiments, anomaly detection ML models may be trained using compliance and audit events and evidence data, which may be subdivided into subsets of data by joining them to the classifier population data sets.

In some embodiments, the above-identified approach to clustering may allow expert users and/or stakeholders to express their knowledge of a domain through a method which is intuitive and easy to implement, maintain, and modify.

The following example is intended to be a simplified example for illustration purposes only, and is not intended to be taken as limiting. Using an example of user/employee populations may illuminate how classification may look in practice. In this example, attributes for a population may include: a) demographic: classification based on age, gender, and the like; b) qualification: education, general experience, specific/relevant experience, length in current position, and the like; c) job: current assignment, job description, job role, pay grade, actual pay, rating, people management, type of employment (full-time, part-time, contractor); and d) organizational structure: team, office location, hours, and the like.

It will be further appreciated that different populations will have different classification context spaces associated therewith, as appropriate for the set of available attributes.

In some embodiments, the population of software applications may be subdivided into different classes. For example, software applications may be financial, marketing, productivity, entertainment, and may also be classified based on the integration patterns (e.g. allowing for single sign-on, requiring a separate set of credentials, storing personally identifying information (PII) or not, and so on). In practice, classification of applications may be complex and based on many application features.

When an event is being processed in real-time, the event may be associated to an application (which application may be part of one or more classes). As such, ML models trained on events specifically related to applications belonging to the same classes would be used, and would be given higher weight in the overall result relative to ML models which were not trained on events related to applications belonging to the same class as the subject application.

Once a classification context space has been populated with attributes and features, the system may perform clustering at block 1604 to identify labels 1605. Labels 1605 may be stored in classification data store 1504. After labels have been identified, for each classification context space, a classification model 1502 may be created and trained 1606 using the labels 1605. In some embodiments, classifiers 1503 may be deployed to run several times a day in order to refresh the classification data store 1504 and keep data up-to-date to reflect changes to the population data in population data store 1501. The results of these classifications may then be subsequently used to separate (e.g. filter) the full compliance/audit event data set used for anomaly detection model training (e.g. models configured to detect outliers).

In some embodiments, there may be multiple classifiers per context space 1601. In some embodiments, multiple classifiers may be created and trained using ensemble techniques, which may enhance overall performance.

Returning to block 1604, clustering may be used as an unsupervised learning method for finding categories, groups, or classes in populations using a subset of attributes (features) as described above. In some embodiments, the pre-processing subsystem may be completely independent and decoupled from other subsystems, which allows for maximum flexibility and efficiency of the overall system.

Clustering algorithms typically group data around centroids using algorithms which measure the distance of each object from a given centroid. This distance conceptually represents the degree of similarity between objects. Commonly used clustering algorithms include, for example, K-Means, and in the context of particularly large data sets it may be advantageous to use any of Density-Based Spatial Clustering of Applications with Noise (DBSCAN), Ordering Points To Identify the Clustering Structure (OPTICS), and Balanced Iterative Reducing and Clustering using Hierarchies (BIRCH).

The process of clustering 1604 is iterative and typically requires significant manual input from humans and a significant amount of time. However, in some embodiments, the clustering step may be separated and used to produce many different clusters which will be later used and evaluated outside of the pro-processing subsystem. This approach may further allow for the use of several different algorithms for each context space (as defined by the set of attributes and features used as inputs from each population). As such, the separation of the clustering step may allow the system to work automatically, autonomously, and continuously given that real-time subsystem 1702 is capable of running many models in parallel.

Typically, clustering techniques will produce a number of clusters, which may or may not lead to an accurate anomaly detection system in real-time (which is one of the purposes of some embodiments of the invention). Significant human intervention is typically required in order to experiment with different algorithms, architectures and configurations in order to arrive at an anomaly detection system which is accurate. Contrastingly, in some embodiments, the system may be optimized automatically, on a layer-by-layer basis, based on a few heuristic inputs (e.g. context space definition, which is coincidentally intuitive and easy to define and/or change). By running many ML models in parallel in real-time, the system may achieve fast operation, and the use of aggregation and ensemble techniques may limit the impact of each model on the overall result, thereby reducing the impact of an inaccurate model. Moreover, the overall system may be optimized and controlled, because the overall result does not depend on any specific model, nor on the order or number of ML models being run. Thus, the overall system can run a single ML model, or any number of ML models without impact the time required. Likewise, models can be added, removed, or changed without impacting the overall result.

Therefore, the automated process based on context space definitions and a templated set of selected clustering algorithms may be sufficient to train ML models when triggered by changes made to context space definitions (which may be initiated by users, or be a result of automated changes from optimizations triggered by the evaluation and monitoring feedback loop 1814). Any such changes to the context space definitions may further automatically trigger full population re-classification once the model is being trained. As such, full population classification can be said to be running continuously and automatically as well.

In some embodiments, the audit and compliance event populations received at 1307 may also be used for classification of each incoming event (which may be based on event attributes and/or event metadata and context attributes). In some embodiments, event attributes may be event type, action type, and the like. In some embodiments, metadata and context attributes may include, for example, the time of day, the device type, and the like. Based on event attributes, it may be possible to differentiate between security-related events (e.g. authentication and authorization failures), and events such as access to a document summary, as well as events not related to user actions (e.g. a disaster recovery exercise or backup completion).

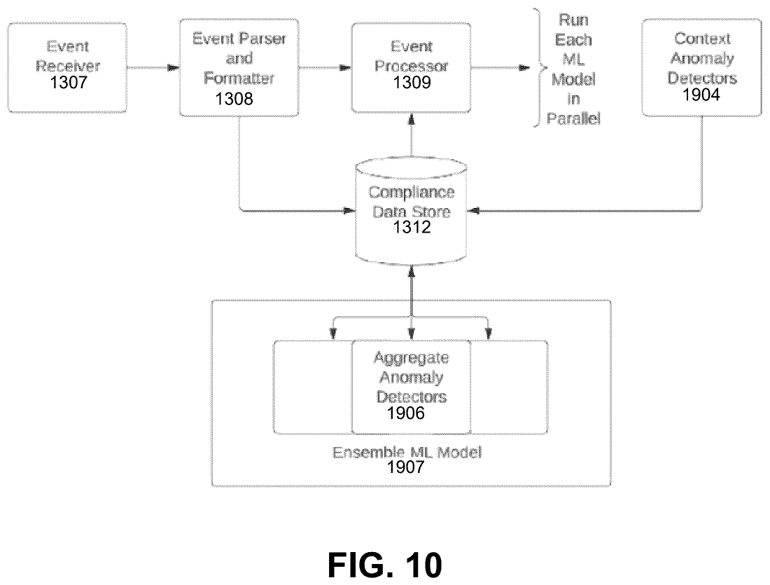

In some embodiments, each incoming event may be processed in real-time through a set of ML engines 1311 (as depicted in FIGS. 4 and 8). ML engines 1311 may process each received event and store the output in compliance data store 1312. FIG. 10 depicts operation of a real-time processing subsystem 1702.

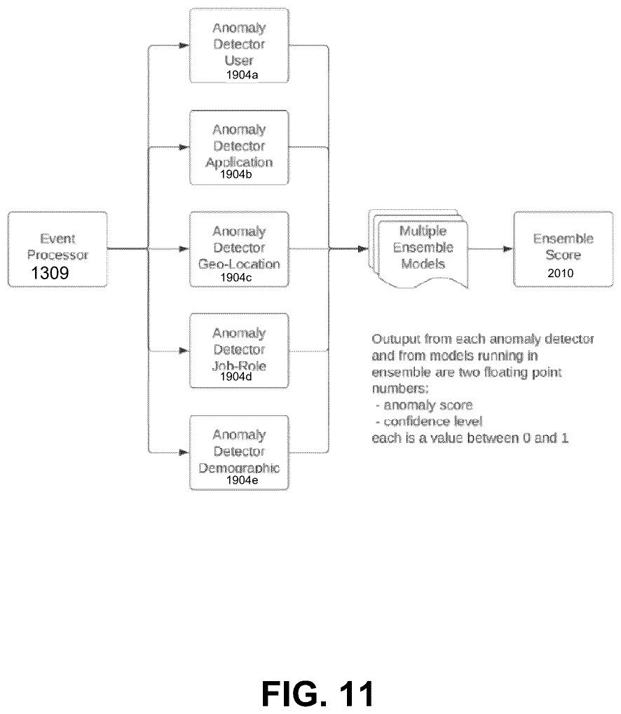

As depicted in FIG. 10, each real-time processing engine (e.g. context anomaly detector 1904) is based on an ML anomaly detection model created through the process depicted in FIG. 9. Results from each real-time engine 1904 may be stored in compliance data store 1312. These results may then be used by the next layer of real-time engines 1906, which form part of an ensemble ML model 1907. As depicted in FIG. 11, in some embodiments, the anomaly detection models 1906 may be trained to perform a specific set of calculations and produce as an output a) a value between 0 and 1 representing an anomaly score, and a confidence value between 0 and 1 representing the degree of confidence in the accuracy of the anomaly score. The ensemble ML model 1907 may take each of these output values from each detection model 1906 (along with possible other attributes) and arrive at a result. The overall result of the models 1906 which form part of the ensemble model 1907 may then be processed by a final ML model.

FIG. 9 depicts how real-time processing subsystem 1702 is developed and bootstrapped, with continuous evaluation and monitoring feedback loop at block 1814. For example, real-time subsystem 1702 uses population identifiers (e.g. lists of users for each job class label 1803, lists of users for each application 1804, lists of users for each geographic location 1805, lists of applications for each authorization class label 1806, and the like) from population data stores 1501 to filter event data at block 1808. At block 1809, training data is created which is then used to train, at block 1810, by ML trainers 1707, independent ML models 1311. In some embodiments, models 1311 may be configured to be run in parallel. At block 1811, ML models 1311 may be tested, with results fed back to block 1809. At block 1812, one or more ML models 1311 are deployed for use.

In some embodiments, the process of training independent ML models does not need to be executed in real-time, and allows for the addition and/or removal of individual real-time ML models that can be run in parallel. In some embodiments, the addition and/or removal of ML models does not affect the real-time engine functionality and can be done in real-time.

In some embodiments, post-processing subsystem may also include automated, continuous evaluation, monitoring and feedback loops (e.g. block 1814 in FIG. 9). The post-processing subsystem may collect performance measurement data on a continuous basis. In some embodiments, performance measurements may include precision, recall, or the like. Performance metrics may be compared to the configurations and stated objectives expressed through performance measurement ranges which may be set by the system administrator and/or stakeholders. In some embodiments, an optimization engine may be used to adjust parameters of the ML models in order to minimize or reduce the difference between targets and real data.

A person skilled in the art will appreciate that in the field of risk and compliance assessment, there are many different types of risks, and many different types of compliance frameworks. Moreover, there are many different domains which have diverging view of risks and compliance. For example, the domains of security, inclusion, and budget may have drastically different approaches to defining and assessing risks and compliance. As a result, there is no single agreed-upon goal or definition across the board for anomaly or outlier detection models. That being said, embodiments of the solution described herein rely on multiple different anomaly detection models, each trained and/or designed to focus on a specific goal. The use of ensemble ML models 1907 may provide a more fulsome and holistic approach to anomaly detection.

There are many different ML anomaly detection algorithms. Examples of ML algorithms include Isolation Forests, Local Outlier Factor (LOF), One-Class Support Vector Machines (SVMs), Autoencoders, DBSCAN, Gaussian Mixture Models (GMM), Mahalanobis Distance, and K-Nearest Neighbours (KNN), to name but a few. It will be appreciated that the choice of the best anomaly detection algorithm will depend on the characteristics of the real-time input data arriving at the system at run-time, as well as possibly historical data. The nature of the anomalies which are desired to be found, and the specific requirements of each domain and/or context are identified in the pre-processing phase. However, it is not practical, particularly for run-time processing, to attempt to find the best fitting anomaly detection algorithm for every specific use case. Instead, some embodiments described herein using a novel approach by using multiple ML models running in parallel. Since the real-time processing system 1702 is de-coupled, it possible to change, add and/or remove use cases through adding, removing or changing models used in the parallel executions.

In some embodiments, the particular anomaly detection algorithm used by ML detectors 1904 is not of particular materiality. Instead, embodiments may actually benefit from using multiple different anomaly detection models in parallel, which may advantageously lead to an increase in the overall accuracy of the system. For example, different anomaly detection algorithms may perform better in low density regions of space, whereas other detection algorithms perform better in high density regions of space. As such, a layered approach to anomaly detection may prove advantageous, particularly with the use of confidence scores from each anomaly detection model 1906.

In some embodiments, using one or more sets of supervised, unsupervised, and semi-supervised ML methods may improve the performance of the system and reduce the complexity of implementation and maintenance.

As depicted in FIG. 9, an important aspect of some embodiments is the use of feedback loop 1814 to monitor the ML model performance. Although this subsystem runs during pre-processing phase, when data is classified, it may also run at run-time, with each component collecting metadata and run-time processing configuration and evaluation data, along with the input and output. This may be stored in compliance data store 1312. The data stored in compliance data store 1312 may allow post-processing to run various general and ML-specific performance analysis algorithms. For example, all of the anomaly detectors 1904a, 1904b, 1904c, 1904d, 1904e depicted in FIGS. 10 and 11 may be evaluated both individually, as well as with respect to the aggregate anomaly detection score (e.g. ensemble score 2010). Based on this feedback loop, individual anomaly detectors 1904 can be evaluated and ML performance metrics can be used as a basis for an automated feedback loop.

Some example ML performance metrics may include, for example, the number of True Positives (TP) and True Negatives (TN), the number of False Positives (FP) and False Negatives (FN), the accuracy (e.g. (TP+TN)/(TP+TN+FP+FN)), the precision (TP/(TP+FP)) and recall (TP/(TP+FN)), F1-Score (2*(Precision*Recall)/(Precision+Recall)), Area Under the ROC Curve (AUC-ROC), and Area Under the Precision-Recall Curve (AUC-PR). It will be appreciated that such metrics are merely examples and not an exhaustive list. Moreover, the choice of metric used is not of particular materiality, as the subsystem will automatically provide feedback to the subsystem responsible for training anomaly detectors, allowing for continuous, automated learning.

In some embodiments, the feedback look 1814 may be an ML model which receives an input of all anomaly scores, all confidence levels, the overall anomaly and confidence scores, and takes as input evidence data type and other characteristics in order to classify the overall output which may then be used as an input to the above-listed measurements.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

What is claimed is:

1. A method of detecting anomalous behaviour in a network, the method comprising:
in a pre-processing phase, classifying a population set to discover context-specific classes via a clustering analysis of each sub-population within said population set and storing said classification in a population data store;
training a plurality of machine learning classification engines based on said population data store and on received compliance and audit events for an application;
receiving a current event;
processing, by said plurality of machine learning classification engines, said current audit event to obtain an anomaly score and a confidence score from each respective classification engine;
determine whether said current event is an anomalous event based on said respective anomaly scores and confidence scores.

2. The method of claim 1, wherein said plurality of machine learning classification engines comprises one or more ensemble models, each of said one or more ensemble models configured to obtain an aggregate score based on respective anomaly and confidence scores from a subset of the plurality of classification engines, and determine whether said current event is anomalous based on the output of said one or more ensemble models.

3. The method of claim 1, wherein said one or more machine learning classifications is configured to detect anomalies in one or more of a user, an application in use, a location, a job role, and/or a demographic.

4. The method of claim 1, further comprising a feedback loop for assessing accuracy of said determination and modifying one or more of said machine learning classification engines in response to said assessment accuracy.

5. The method of claim 1, wherein each of said respective confidence scores and anomaly scores is a value between 0 and 1.

6. The method of claim 1, wherein each of said plurality of machine learning classification engines executes in parallel and independently from other machine learning classification engines of said plurality of machine learning classification engines.

7. The method of claim 4, wherein said feedback loop comprises a plurality of feedback loops for each respective machine learning classification engine of said plurality of machine learning classification engines, and wherein each of said plurality of feedback loops is executed in parallel and separately from others of said plurality of feedback loops.

8. A system for detecting anomalous behaviour in a network, the system comprising:
one or more processors;
a non-transitory computer-readable storage medium having stored thereon processor-executable instructions that, when executed by said one or more processors, cause the one or more processors to perform a method comprising:
in a pre-processing phase, classifying a population set to discover context-specific classes via a clustering analysis of each sub-population within said population set and storing said classification in a population data store;
training a plurality of machine learning classification engines based on said population data store and on received compliance and audit events for an application;
receiving a current event;
processing, by said plurality of machine learning classification engines, said current audit event to obtain an anomaly score and a confidence score from each respective classification engine;
determine whether said current event is an anomalous event based on said respective anomaly scores and confidence scores.

9. The system of claim 8, wherein said plurality of machine learning classification engines comprises one or more ensemble models, each of said one or more ensemble models configured to obtain an aggregate score based on respective anomaly and confidence scores from a subset of the plurality of classification engines, and determine whether said current event is anomalous based on the output of said one or more ensemble models.

10. The system of claim 8, wherein said one or more machine learning classifications is configured to detect anomalies in one or more of a user, an application in use, a location, a job role, and/or a demographic.

11. The system of claim 8, further comprising a feedback loop for assessing accuracy of said determination and modifying one or more of said machine learning classification engines in response to said assessment accuracy.

12. The system of claim 8, wherein each of said respective confidence scores and anomaly scores is a value between 0 and 1.

13. The system of claim 8, wherein each of said plurality of machine learning classification engines executes in parallel and independently from other machine learning classification engines of said plurality of machine learning classification engines.

14. The system of claim 11, wherein said feedback loop comprises a plurality of feedback loops for each respective machine learning classification engine of said plurality of machine learning classification engines, and wherein each of said plurality of feedback loops is executed in parallel and separately from others of said plurality of feedback loops.

15. A non-transitory computer-readable storage medium having stored thereon processor-executable instructions that, when executed by one or more processors, cause the one or more processors to perform a method comprising:
in a pre-processing phase, classifying a population set to discover context-specific classes via a clustering analysis of each sub-population within said population set and storing said classification in a population data store;
training a plurality of machine learning classification engines based on said population data store and on received compliance and audit events for an application;
receiving a current event;
processing, by said plurality of machine learning classification engines, said current audit event to obtain an anomaly score and a confidence score from each respective classification engine;
determine whether said current event is an anomalous event based on said respective anomaly scores and confidence scores.

16. The non-transitory computer-readable storage medium of claim 15, wherein said plurality of machine learning classification engines comprises one or more ensemble models, each of said one or more ensemble models configured to obtain an aggregate score based on respective anomaly and confidence scores from a subset of the plurality of classification engines, and determine whether said current event is anomalous based on the output of said one or more ensemble models.

17. The non-transitory computer-readable storage medium of claim 15, wherein said one or more machine learning classifications is configured to detect anomalies in one or more of a user, an application in use, a location, a job role, and/or a demographic.

18. The non-transitory computer-readable storage medium of claim 15, further comprising a feedback loop for assessing accuracy of said determination and modifying one or more of said machine learning classification engines in response to said assessment accuracy.

19. The non-transitory computer-readable storage medium of claim 15, wherein each of said plurality of machine learning classification engines executes in parallel and independently from other machine learning classification engines of said plurality of machine learning classification engines.

20. The non-transitory computer-readable storage medium of claim 18, wherein said feedback loop comprises a plurality of feedback loops for each respective machine learning classification engine of said plurality of machine learning classification engines, and wherein each of said plurality of feedback loops is executed in parallel and separately from others of said plurality of feedback loops.
